(19) United States
(12) Patent Application Publication
(10) Pub. No.: US 2016/0275752 A1
(43) Pub. Date: Sep. 22, 2016

(54) METHOD AND SYSTEM FOR FUNDRAISING THROUGH A MULTIPLAYER COMPETITIVE EVENT

(71) Applicant: Robert Rosenbaum, South Kortright, NY (US)

(72) Inventor: Robert Rosenbaum, South Kortright, NY (US)

(21) Appl. No.: 15/061,426

(22) Filed: Mar. 4, 2016

Related U.S. Application Data
(60) Provisional application No. 62/134,684, filed on Mar. 18, 2015.

(51) Int. Cl. G07F 17/32; G06Q 50/34

(52) U.S. Cl. CPC G07F 17/3244; G06Q 50/34

(57) ABSTRACT

A method for collecting funds through a competitive event involving multiple participants. The method comprising selecting an objective and a time limit for the competitive event and providing a plurality of predefined choices, each choice represented by an avatar, for fulfilling the selected objective. Allowing participants to place mock bets on one or more avatars based on preferred choices, before the end of the time limit and displaying relative advancement of each avatar towards fulfilling the objective based on total funds accrued by each avatar in form of mock bets. After the time limit, the avatar, which had accrued maximum funds in the form of mock bets, is selected as a winning choice.

### CROSS-REFERENCE TO RELATED APPLICATIONS

This application claims priority to U.S. application No. 62/134,684 titled “System and method of collecting funds via a multiplayer real-time interactive game”, filed on Mar. 18, 2015, which is incorporated herein by reference in its entirety.

### BACKGROUND

1. Field of the Invention

The present invention generally relates to methods of collecting funds through interactive activities, more specifically relates to system and method for collecting funds by employing multiplayer competitive events or games.

2. Description of Related Art

Fundraising refers to a process of soliciting financial support for a particular purpose. It is common for an organization or an individual seeking funds to auction off the right to choose a name or to choose some other specification (e.g. a song, a title, a mascot) related to a cause or an event. While many supporters or participants may bid on their preferred choice, in the end the right goes exclusively to the highest bidder, thereby depriving other supporters of input as well as capturing only the funds of the winning bidder. Should a conventional bidding system require non-winning bids to be non-refundable it could alienate supporters. While individual “bid pooling” is possible it is highly unorganized and alienates potential bidders.

Traditional fundraising events such as walkathons, charity runs and races allow only a selected group of people to participate and contribute funds. Some organizations raise funds through online auctions and websites, but failed to utilize the full potential of online tools or online community for collecting funds. One of the major challenges in a fund raising event is how to engage the entire supporter base while capturing all potential funds being bid. There is a need for a system and method that allows a fundraiser to capture all bid monies while engaging all their supporters in a decision making processes.

Accordingly, there exists a need for an improved method or system for collecting funds by employing multiplayer competitive games or activities that encourages active participation by the entire supporter base and fund collection from all participants.

### SUMMARY OF THE INVENTION

The present invention relates to a system and method of fundraising by setting up a game in the form of a race. The game comprises at least one objective or a goal, usually related to the cause or event that necessitated the fundraising. A few examples of objectives may include, naming a rescue animal, selecting a school mascot, choosing a theme song for an event, naming a sports team and the like. Choices that are available for fulfilling a particular objective are represented by avatars. Supporters or participants are allowed to place mock bets on at least one avatar representing their choice. Each avatar advances by way of funds contributed by supporters in the form of mock bets on their favorite avatar. The race is set for a predetermined amount of time, but without a cap on the amount of funds to be raised. Supporters may place as many mock bets as they want. At the end of the race time, the avatar with the most funds determines the winning selection.

In an embodiment, the fundraiser creates a game with at least one objective or goal of making a single winning selection from a collection of predefined choices. The supporters contribute funds in the form of mock bets placed on their preferred choice represented as avatars. Contributions from the supporters are immediately delivered directly to the fundraiser. The game comprises of components designed specifically to encourage participation by supporters thereby increasing funds and supporter engagement.

### BRIEF DESCRIPTION OF THE DRAWINGS

FIG. 1 illustrates a flowchart showing a method for collecting funds through a competitive event.

FIG. 2 illustrates an exemplary display screen for the competitive event.

FIG. 3 shows an exemplary image of a ticket.

FIG. 4 illustrates a block diagram of a system for collecting funds through a competitive event.

### DETAILED DESCRIPTION OF DIFFERENT EMBODIMENTS

The terms “participant”, “player”, “supporter” has been used interchangeably herein, referring to the users taking part in the competitive event, who are entitled to select at least one avatar and contribute to advancement of the avatar towards fulfilling the objective by placing one or more mock bets on the corresponding respective avatar.

The term “mock bet” refers to a quantifiable means used to support one or more choices from a pool of predetermined choices and does not involve placement of wager.

The present invention pertains to a system and a method for collecting funds through a competitive game or event with a predetermined end time or game duration, played simultaneously by an unlimited number of participants or supporters. The competitive game comprises a fixed objective and a number of predetermined choices for fulfilling the objective. Each predetermined choice is represented by an avatar and participants pool funds by placing mock bets on one or more avatar based on their preferred selection among predetermined choices. During the end of game duration, a winning choice is determined based on the funds; the predetermined choice associated with the avatar that accrued maximum funds will be selected as the winning choice.

The present invention allows a person or an organization wishing to raise funds for a cause or an event by conducting a competitive game, which encourages participation and monetary contribution from the entire supporter base (all participants) in the process of selecting a winning choice. For instance, the goal or objective of a game may be choosing the name of a rescue animal from a small pool of names. Another example would be a game run to choose a mascot for a school or choose a theme song for a project. Any goal that requires a simple selection from a pool of predetermined choices could be the goal of a game. It is preferable to have a goal that is associated with the reason behind fund raising. For example, In the case of fundraising for animal care, the goal can be “naming a rescue animal”. Alternatively, if the fund raising is to help school activities, then the goal can be choosing a mascot for the school.

Once the goal is chosen, the selection choices are determined and the time frame or end time for the game is set. The goal is clearly displayed near the field of play for all to see. The avatars for each of the predetermined choices are set to the beginning position of their respective lanes and the timer is set. A ticket is set up with labels clearly displaying the choices represented by the avatars along with an adjacent check box for a player to make her selection. A box or line should be provided for the amount the player wishes to contribute to their choice. Participants are required to purchase the tickets, make selection of their preferred choice and place a mock bet using the ticket.

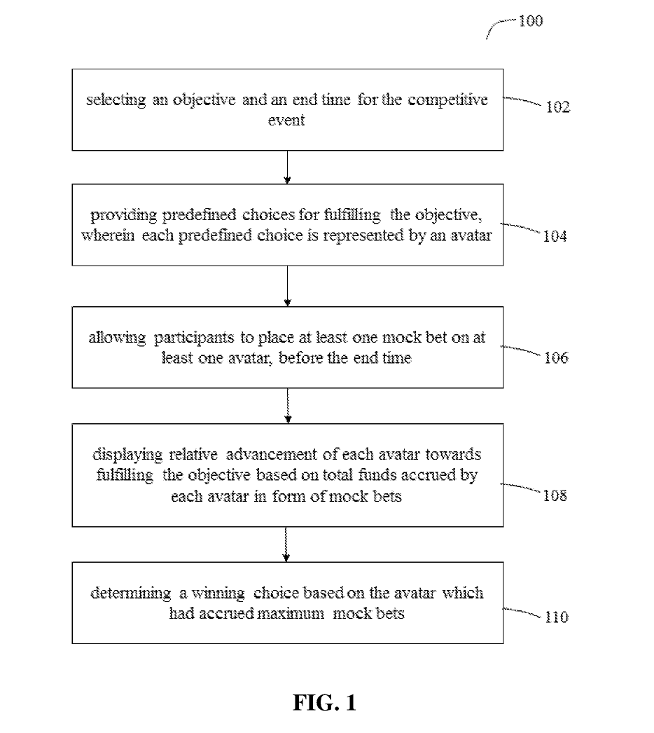

Referring to FIG. 1, which illustrates a flowchart showing a method for collecting funds through a competitive event. The method 100 comprises the steps of: selecting an objective and an end time for the competitive event, as shown in step 102; providing predefined choices for fulfilling the objective, wherein each predefined choice is represented by an avatar, as shown in step 104; allowing participants to place at least one mock bet on at least one avatar, before the end time, as shown in step 106; displaying relative advancement of each avatar towards fulfilling the objective based on total funds accrued by each avatar in form of mock bets, as shown in step 108; and determining a winning choice based on the avatar which had accrued maximum mock bets, as shown in step 110.

In an embodiment, the method 100 for collecting funds through competitive event further comprises collecting money for every mock bet placed on every avatar from respective participants. For example, the competitive event may comprise a race, which allows multiple participants to take part in fulfilling the objective by choosing their preferred choice represented by an avatar. Here, participants help in advancement of avatars towards the end line (fulfillment of objective), by contributing funds in form of mock bets placed on preferred avatars. The total fund corresponding to pooled mock bet amount contributed by all participants during the game, irrespective of winning choice, is transferred to the fundraiser.

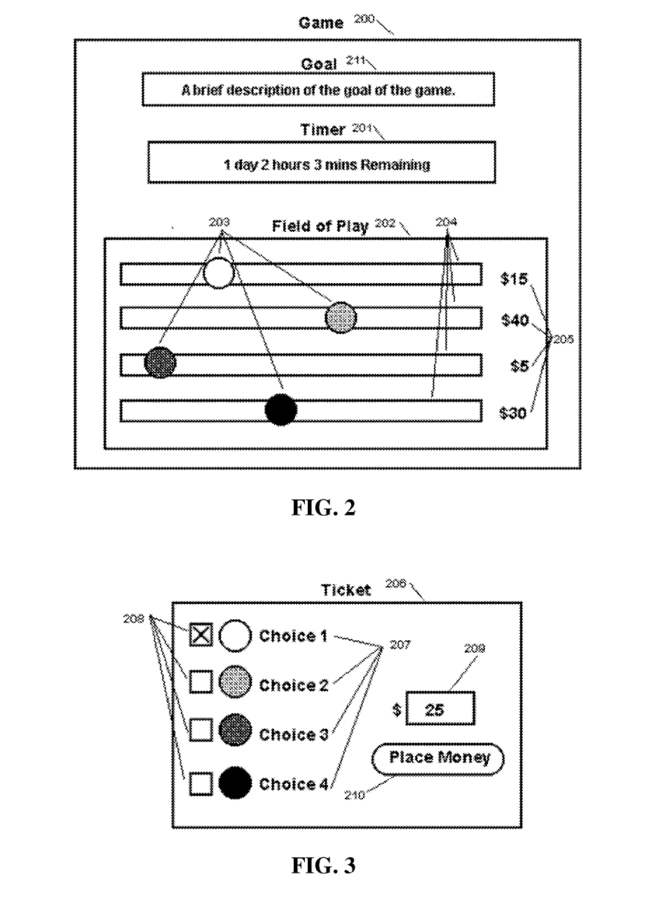

The competitive event or game can be played real time, in a venue or electronically such as an online game. In an embodiment, the competitive event or game can be conducted real time in a stage, stadium, inside a studio or an open arena. The game could be set up manually (as on a white board) or mechanically (as on a scoreboard) to be hosted at a live event or on a broadcast medium. For example, the real time game in a venue comprises a display board or display screen showing the real time progress of each avatar towards the goal. FIG. 2 illustrates an exemplary display board for the game 200 showing the objective or goal 211 of the game 200, wherein a brief description of the goal 211 is displayed for the audience and participants. The display further comprises a timer 201, showing time remaining for the game to end and a field of play 202 comprising a plurality of lanes 204, one lane for each avatar 203, which in turn represents one of the predefined choices. Total funds 205 accrued by each avatar is also displayed at an end of each lane.

As illustrated in FIG. 2, each game 200 has a goal 211 and predetermined ending time. The timer 201 is a countdown timer. The timer 201 creates a sense of urgency as well as denoting the end of the game. The timer 201 counts down days, hours, minutes in real-time. The field of play 202 is the visual representation of the race. The lanes 203, each lane dedicated for an avatar 204, the length of the lane represents the duration of the race. The avatars 204 are a visual representation of each of the choices. The position of each avatar 204 within the lane 203 is a visual representation of how far along the choice is in the race relative to the other choices and the time remaining in the race.

As participants or supporters place mock bets on their avatar for contributing funds to the choice they want to win, the respective avatar 204 is moved along the lane 203 towards the goal 211. At the end of each lane 203 is a total fund 205, the numerical representation of the cumulative funds “placed” upon the respective choice. As more funds are contributed to each choice, their avatar 204 is moved along the lane 203 and the total fund amount 205 will increase in real-time.

In an embodiment, the participants are required to purchase a ticket for placing each mock bet. FIG. 3 shows an exemplary ticket 206 comprising a list of predefined choices, each choice with a label 207, the choices are selectable using their respective selection boxes 208 adjacent to each label 207. The ticket 206 further comprises an amount field 209, for example, $25 mock bet amount, and a payment trigger 210 for initiating the transaction of mock bet amount paid to the fundraiser or debited by the fundraiser from the participant account. For example, the ticket 206 comprises a place money 210 field to confirm placement of the mock bet. In an exemplary embodiment, the tickets 206 can also be purchased by paying the mock bet amount or a part of the mock bet amount upfront.

The ticket 206 is the functional device for the supporters to “place their mock bets” or make their contributions. The supporter makes their selection 208, enters an amount 209 and makes the payment 210. The method of payment attached to the payment trigger 210 can be any form, mechanical, electronic or manual, as long as it is collected immediately. Each contribution, whether taken mechanically, electronically or manually, is immediately reflected in the field of play 202 whether the update is handled mechanically, electronically or manually.

In an electronic environment over a network, the ticket 206 is displayed to the player on his device with a button for the implementation of payment. In a real world environment, the ticket 206 could be printed on cards and the payment made when the card is turned in. In a broadcast situation, the ticket 206 could be displayed and the player could make their selection via telephone or text, paying by credit card or pledge if the Fundraiser allows. The funds are non-refundable, not dependent on the outcome of the game; instead, they influence the outcome of the game.

The field of play is adjusted at each new display. Based on the funding contributed for each avatar (representing a predetermined choice), the position of each avatar in its respective lane changes relative to the position of other avatars. Participants may contribute, as many times and as much as they want. With each contribution, they may select any choice, for example, the participants may shift to a different choice and are not bound by their initial choice. The game continues this way throughout the game duration. At the end of the time, the avatar with the most funds will be determined as the winning selection.

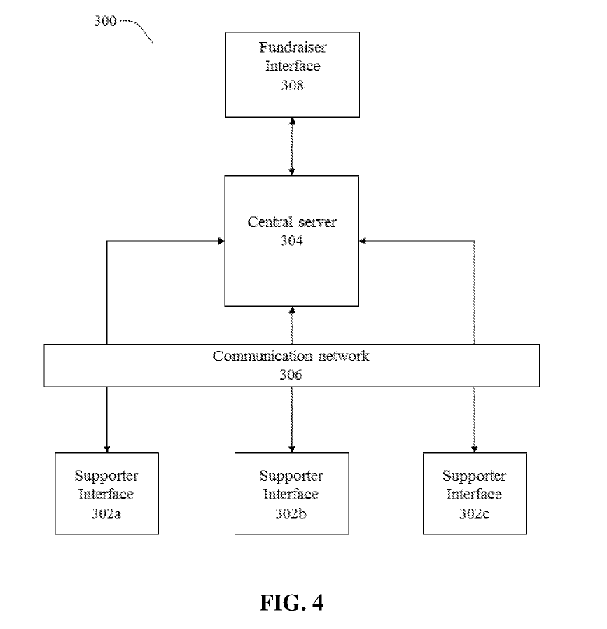

FIG. 4 shows a system 300 for collecting funds online through a competitive event. The system 300 comprises a plurality of supporter interface 302a, 302b, 302c connected to a central server 304 via a communication network 306 such as internet. The central server 304 is connected to a fundraiser interface 308 comprising an individual or an organization with a computing device. The fundraiser interface 308 is configured to select a goal, a time limit and predetermined choices for fulfillment of the goal for the event, wherein each predetermined choice is represented by an avatar. The supporter interface 302a-c comprises a mobile device or an electronic device using which the supporters connect to the central server 304 for registering and participating in the competitive event. The plurality of supporter interface 302a-c are used for placing at least one mock bet on at least one avatar by each supporter for advancement of the avatar towards the goal before the time limit ends.

The central server 304 is configured to determine a real time advancement of avatars relative to each other towards the goal, based on total mock bet accrued by each avatar. The central server 304 comprises a database for storing details on predetermined choices, participants, mock bet amount and real time status of avatar calculated based on accrued mock bet amount. A financial transaction module for receiving mock bet amount from participants and transfer of amount corresponding to the mock bet to the fundraiser.

Supporters can connect with the central server 304 through the supporter interface 302a-c such as a computing device comprising a processor and a memory. In an embodiment, the central server 304 may comprise a website with details on the game, objective and predefined choices. Supporters can register and purchase tickets from the website through online transaction. Once the game begins, the website displays the play field showing the progression of avatars and time remaining for the game to complete. At the end of time limit, the choice associated with the avatar that accrued most funds is displayed as a winning choice. The supporter interface 302a-c comprises a display for visually representing the real time advancement of avatars towards the goal. The cumulative fund amount is transferred through the fundraiser interface 308 to the fundraising organization or individual. The cumulative fund amount corresponds to the total mock bet amount placed on all avatars by every participant during the course of the game, irrespective of the winning selection.

The various embodiments described above are provided by way of illustration only and should not be construed to limit the claims attached hereto. Those skilled in the art will readily recognize various modifications and changes that may be made without following the example embodiments and applications illustrated and described herein and without departing from the true spirit and scope of the following claims.

What is claimed is:

1. A method for collecting funds through a competitive event involving multiple participants, the method comprising:
selecting an objective and a duration for the competitive event;
providing predefined choices for fulfilling the objective, wherein each predefined choice is represented by an avatar;
allowing participants to place at least one mock bet on at least one avatar, before end of the duration;
displaying relative advancement of each avatar towards fulfilling the objective based on total funds accrued by each avatar in form of mock bets; and
determining a winning choice based on the avatar which had accrued maximum mock bets.

2. The method of claim 1, further comprises collecting money for every mock bet placed on every avatar from respective participants.

3. The method of claim 1, wherein the competitive event comprises a race.

4. The method of claim 1, wherein the mock bets are placed by purchasing a ticket.

5. The method of claim 4, wherein the ticket comprises a plurality of predefined choices selectable by the participant.

6. The method of claim 4, wherein the ticket comprises a mock bet amount and a payment trigger for the mock bet amount.

7. A system for collecting funds through an online competitive event, comprising:
a fundraiser interface configured to select a goal, a time limit and predetermined choices for fulfillment of the goal for the event, wherein each predetermined choice is represented by an avatar;
a central server connected to the fundraiser interface via a communication network, and
a plurality of supporter interface connected to the central server, for placing at least one mock bet on at least one avatar by each supporter for advancement of the avatar towards the goal before the time limit ends;
wherein the central server is configured to determine a real time advancement of avatars relative to each other towards the goal, based on total mock bet accrued by each avatar.

8. The system of claim 7, wherein the fundraiser interface and the supporter interface comprises a computing device.

9. The system of claim 7, wherein the communication network comprises an internet network.

10. The system of claim 7, wherein the supporter interface comprises a display for visually representing the real time advancement of avatars towards the goal.
